(19) United States
(12) Patent Application Publication
(10) Pub. No.: US 2007/0067542 A1
(43) Pub. Date: Mar. 22, 2007

(54) Microcontroller architecture including a predefined logic area and customizable logic areas

(75) Inventor: Alain Vergnes, Trets (FR)

Correspondence Address: SIERRA PATENT GROUP, LTD., 1657 Hwy 395, Suite 202, Minden, NV, 89423, US

(73) Assignee: Atmel Corporation

(21) Appl. No.: 11/412,317

(22) Filed: Apr. 26, 2006

(30) Foreign Application Priority Data
Aug. 29, 2005 (FR) 05 08819

(51) Int. Cl. G06F 13/40

(52) U.S. Cl. 710/307

(57) ABSTRACT

A microcontroller architecture in accordance with this invention provides modules or circuitry that may be programmed with a protocol for communication or other application. The architecture in accordance with this invention provides at least one module on a high bandwidth or system bus and a second module on a second low bandwidth or peripheral bus that allows a maker to program a module needing specified processing bandwidths using the desired bus. This allows microcontrollers to be produced that are adaptable without a great increase of cost or loss functionality.

### CROSS REFERENCE TO RELATED APPLICATION

This application claims priority to co-pending French Patent Application Serial Number 05 08819, filed Aug. 29, 2005, which is hereby incorporated by reference as if set for the herein.

### FIELD OF THE INVENTION

This invention relates to microcontrollers. More particularly, this invention relates to peripheral devices in a microcontroller. Still more particularly, this invention relates to providing a first configurable device on a first bus and a second configurable device on a second bus.

### PRIOR ART

Most electronic devices produced today include some sort of microcontroller. The microcontrollers execute software applications in an electronic device to provide a function. For example, microcontrollers are often used to provide measurement or to perform other calculations. Thus, producers of electronic devices strive to reduce the cost of microcontrollers in order to reduce the cost of electronic devices.

In order to reduce the cost of microcontrollers, makers of microcontrollers are always trying to take advantage of economics of scale. Therefore, makers of microcontrollers are constantly striving to find ways to mass produce microcontrollers. One problem with mass producing microcontrollers is making microcontrollers that perform a wide variety of applications.

In order to perform a wide variety of applications, microcontrollers must be able to communicate using a number of different protocols. Some examples of the various protocols include, but are not limited to, SPI, UART, USB, and Ethernet. Thus, microcontrollers typically include a number of circuits or modules. Each module provides communication using a particular protocol. It is a problem that adding modules for each protocol increases the silicon area of the microcontroller, which in turn increases the cost of production. Furthermore, some of the modules are unused in most applications as a microcontroller only communicates using some but not all of the protocols. Thus, there is a waste of space in the microcontroller and an unneeded increase in price of the microcontroller. Thus, there is a need for a manner for providing circuitry or module for providing a protocol with having to place many alternative modules in a microcontroller.

### SUMMARY OF THE INVENTION

The above and other problems are solved and an advance in the art is made by a microcontroller architecture in accordance with this invention. A microcontroller architecture in accordance with this invention, provides modules or circuitry that may be programmed with a protocol for communication or other application. The architecture in accordance with this invention provides at least one module on a high bandwidth or system bus and a second module on a second low bandwidth or peripheral bus that allows a maker and/or user to program a module to perform an application requiring a specified bandwidth using the desired bus. This allows microcontrollers to be produced that are adaptable without a great increase of cost or loss functionality.

In accordance with this invention, a microcontroller includes a processing unit. A first or system bus connects the processing unit to high bandwidth modules. The high bandwidth modules include, but are not limited to on-chip memories, and direct memory access controllers. A second bus connects the processing unit to low and/or medium bandwidth transfer modules. The low and/or medium bandwidth transfer devices typically include peripheral devices used by the processing unit to perform efficient software applications

A first module connected to the first bus includes configurable circuitry for providing high bandwidth applications. The first module may have a low cell density to allow for high frequencies, high bandwidth that can be achieved on the first bus. A second module connected to the second bus includes configurable circuitry for providing low bandwidth applications. The second module may have a high cell density to allow for more complex and slowed bandwidth applications. The first and second modules may be Field Programmable Gated Arrays (FPGAs) or Pre-diffused gate array logic modules.

The microcontroller may also include a pre-defined logic bus bridge that connects the second bus to the processing unit through the first bus. The bus bridge translates signals between the first and second bus to allow signals to and from the second bus to be transmitted over the first bus.

### BRIEF DESCRIPTION OF THE DRAWINGS

The above and other aspects and advantages of this invention are described in the following detailed description and are shown in the following drawings:

FIG. 1 illustrating a block diagram of a prior art microcontroller; and

FIG. 2 illustrating a block diagram of a microcontroller in accordance with a first exemplary embodiment of this invention.

### DETAILED DESCRIPTION

This invention relates to an architecture for microcontrollers. The following is a description of exemplary embodiments in accordance with this invention. Where appropriate, components shown on different figures are given the same reference numeral throughout the description.

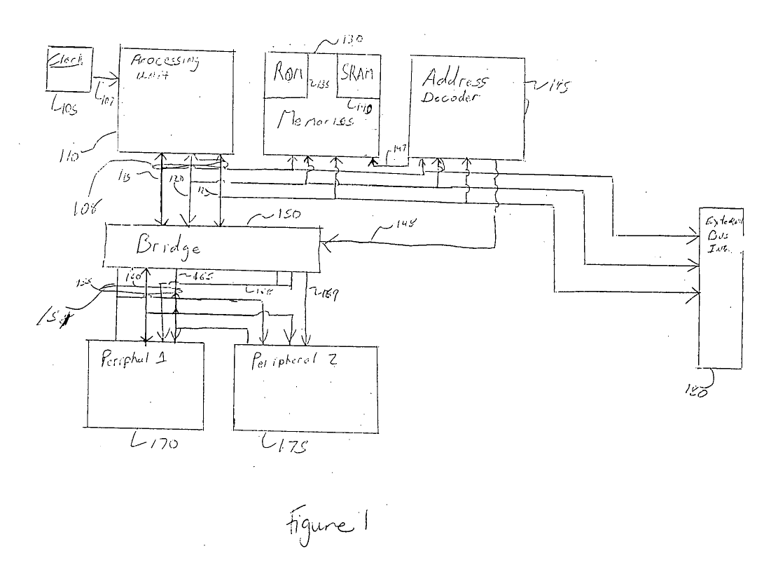

FIG. 1 illustrates a block diagram of a prior art microcontroller 100. Microcontroller 100 includes a processing unit 110. Processing unit 110 is a processor, microprocessor, or combination of microprocessors and/or processors that execute instructions to perform a function. Process unit 110 receives timing signals from a clock 105 via path 107. Clock 105 is circuitry that generates timing signals for operation of microcontroller 100. One skilled in the art will recognize that clock 107 may be a clock local to microcontroller 100 or a system clock depending upon the exact configuration of a system including microcontroller 100.

Processing unit 100 is connected first or system bus 108. First or system bus 108 is connected to high bandwidth devices that processing unit 110 must communicate with to perform applications. For purposes of this discussion, a high bandwidth device is a device that transfers data at or near the maximum achievable bandwidth for a given frequency of the bus and/or processing unit. For example, a system memory is a high bandwidth device because the memory operates at a maximum bandwidth of the bus. In particular, a microcontroller having a 32 bit bus with a 100 MHz clock has a memory that transfers data at a rate of 3.2 Gbits/second. Furthermore, for purposes of this discussion, low bandwidth devices are devices that transfer data at a rate that is significantly lower than high bandwidth devices. In most embodiments, the ratio of the bandwidth for low bandwidth devices to the bandwidth of high bandwidth devices is 10:100. In most embodiments, the bandwidth of low bandwidth devices may range from a few Kbits/second to 100 Mbits/second. Some examples of low bandwidth devices in the above described system include a USB 1.1 module having a rate of 12 Mbits/second, an SPI module having a rate of about 10 Mbits/second, and an Uart module being able to run at up to a range from a few Kbits/second to a few Mbits/second where standard rates are 19.2 Kbits/second and 115.2 Kbits/second.

In this particular embodiment, high bandwidth devices connected to first bus 108 include memories 130, address decoder 145, and external bus interface 180. One skilled in the art will recognize that other high bandwidth devices may be connected to first bus 108 depending on the configuration of the system including microcontroller 100.

First bus 108 includes address bus 115, data bus 120, and read/write signal 125. Address bus 115 transmits the address of a device or module communicating with processing unit 110. Data bus 120 transmits the data between the addressed device or module and processing unit 110. Read/write signal 125 transmits signals indicating whether data is to be read from or written to the addressed device or module.

First bus 108 is used by processing unit 110 to communicate with high bandwidth devices such as memories 130 and address decoder 145. Typically, these are devices that store or provide data needed to execute instructions in processing unit 110. Memories 130 include non-volatile memory, such as Read Only Memory (ROM) 135 and volatile memory, such as Static Random Access Memory (SRAM) 140. ROM 135 is a non-volatile memory that stores configuration information and instructions booting the system. One skilled in the art will recognize that although shown as a ROM other types of non-volatile memory may be used instead depending upon design and system requirements. SRAM 140 stores data to perform user applications. One skilled in the art will recognize that although shown as a SRAM other types of volatile memories may be used. In addition to receiving signals via first bus 108, memories 130 also receives a memory selection signal from address decoder 145 via path 147. The memory selection signal indicates whether the transmitted address applies to ROM 135 or SRAM 135.

Address decoder 145 translates addresses transmitted over address bus 115. The signals applied to address bus 115 are received by address decoder 145. Address decoder 145 decodes the signals and generates selection signals. The selection signals are mutually exclusive and indicate which connected devices must read the signals applied to bus 115. The selection signals are then applied to paths 168-169. Typically, for each ranges of addresses a signal will only be applied to one of paths 167-169 while the remaining paths are de-asserted.

External bus interface 180 connects microcontroller 100 to other devices (Not Shown) in the system or final product. External bus interface 180 receives signals over first bus 108, translates the signals to a protocol used for communication over an external bus, and applies the translated signals to the external bus. External bus interface 180 also receives signals from the other devices, translates the received signals to the protocol used for communication over first bus 108, and applies the translated signals to first bus 108.

Bus bridge 150 connects a second bus 151 to first bus 108. When a device on the second bus is being addressed on address bus 120 of first bus 108, address decoder 145 sends a bridge select signal to bus bridge 150 via path 148. Bus bridge then translates signals between the protocols used on first bus 108 and second bus 151. Bus bridge 150 also generates selection signals to the peripheral device being used and routs the selection signals to the proper peripheral device via path 168 and 169.

Second bus 151 connects to bus bridge 150 to connect peripheral and other devices to processing unit 110. Second bus 151 includes read/write signal 155, address bus 160, and data bus 165. Read/write signal 155 transmits signals indicating whether data is being read from or written to the address indicated by signals on address bus 160. Address bus 160 transmits signals indicating the address associated with the data applied on data bus 165 to the peripheral devices connected to second bus 151. Data bus 165 transmits data between a peripheral device and processing unit 110 through bridge 150.

Peripheral device 170 and 175 are circuitry that provide data to processing unit 110 to perform an application. The exact peripheral devices in microcontroller 100 do not matter for purposes of this invention and exact configurations of the devices are omitted for brevity. One skilled in the art will recognize that any number of peripheral devices may be connected to second bus 151 depending on the configuration and requirements of the system including microcontroller 100.

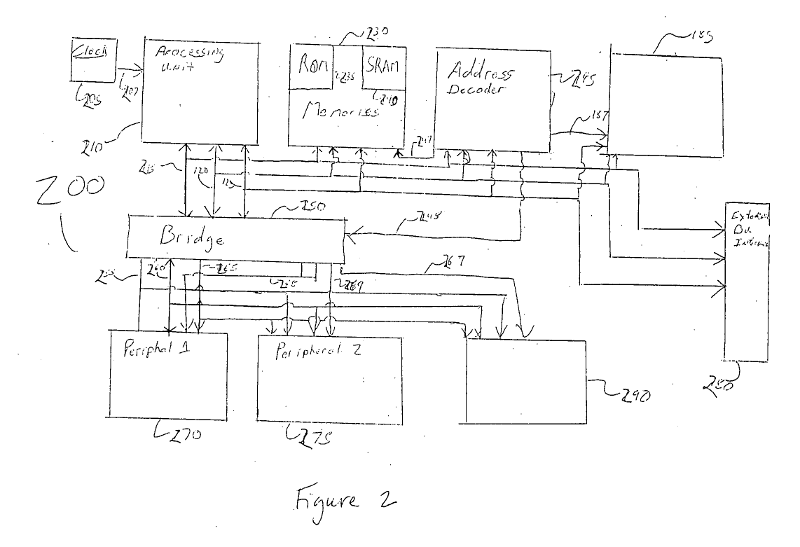

This invention relates to providing configurable circuit modules to allow a user or maker to configure the modules for a specific function based upon system requirements. FIG. 2 illustrates exemplary embodiments for a microcontroller providing configurable circuit modules in accordance with this invention.

FIG. 2 illustrates a microcontroller 200 providing a first configurable circuit module on a first high bandwidth bus and a second configurable circuit module on a second low bandwidth bus. FIG. 2 illustrates a block diagram of an exemplary microcontroller 200 in accordance with this invention. Microcontroller 200 includes a processing unit 210. Processing unit 210 is a processor, microprocessor, or combination of microprocessors and/or processors that execute instructions to perform a function. Processing unit 210 receives timing signals from a clock 205 via path 207. Clock 207 is circuitry that generates timing signals for operation of microcontroller 200. One skilled in the art will recognize that clock 207 may be a clock local to microcontroller 200 or a system clock depending upon the exact configuration of a system including microcontroller 200.

Processing unit 210 is connected to first or system bus 208. First or system bus 208 is connected to high bandwidth devices that processing unit 210 must communicate with to perform application. In this embodiment, high bandwidth devices connected to first bus 208 include memories 230, address decoder 245, and external bus interface 280. One skilled in the art will recognize that other high bandwidth devices may be connected to first bus 208 depending on the configuration of the system including microcontroller 200.

First bus 208 includes address bus 215, data bus 220, and read/write signal 220. Address bus 215 transmits the address of a device or module communicating with processing unit 210. Data bus 220 transmits the data between the addressed device or module and processing unit 210. Read/write signal 225 transmits signals indicating whether data is to be read from or written to the addressed device or module.

First bus 208 is used by processing unit 210 to communicate with high devices such as memories 230. Typically, these are devices that store or provide data needed to execute instructions in processing unit 210. Memories 230 include non-volatile memory, such as Read Only Memory (ROM) 235 and volatile memory, such Static Random Access Memory (SRAM) 240. ROM 235 is a non-volatile memory that stores configuration information and instructions for booting the system. One skilled in the art that although show as a ROM other types of non-volatile memory may be used instead depending upon design and system requirements. SRAM 240 stores data to perform user applications. One skilled in the art will recognize that although shown as a SRAM other types of volatile memories may be used. In addition to receiving signals via first bus 208, memories 230 also receives a memory selection signal from address decoder 245 via path 247. The memory selection signal indicates whether the transmitted address applies to ROM 235 or SRAM 240.

Address decoder 245 translates addresses transmitted over address bus 215. The signals applied to address bus 215 are received by address decoder 145. Address decoder 245 decodes the signals and generates selection signals. The selection signals are mutually exclusive and indicate which connected devices must read the signals applied to bus 215. The selection signals are then applied to paths 268-269. Typically, for each range of addresses, a signal will only be applied to one of paths 267-269 while the remaining paths are de-asserted.

External bus interface 280 connects microcontroller 200 to other devices (Not Shown) in the system. External bus interface receives signals over first bus 208 and provides the signal to an external bus. External bus also receives signals from the other devices and applies the signals to first bus 208.

In accordance with this exemplary embodiment of this invention, first bus 208 is also connected to first configurable circuit module 285. First configurable circuit module is also connected to address decoder 245 to receive selection signals indicating the data applied to the bus is dedicated to module 285. First configurable circuit module 285 may be configured to provide any application desired by a designer. The configuration of module 285 may be performed by programming the circuit or customizing the circuit to provide the application.

First configurable circuit module circuit module 285 is connected to first bus 208 in order to allow the designer to program any application that requires high bandwidth communication with processing unit 210. Examples of some applications include decoding address and data busses, performing encryption or decryption, performing as an Ethernet protocol interface.

First configurable circuit module 285 may be a Field Programmable Gate Array (FPGA) or pre-diffused gate array logic. Preferably, first configurable circuit module has a low cell density to facilitate high bandwidth applications.

If first configurable circuit module 285 is a pre-diffused gate array circuit, pre-diffused gate array is designed with sufficient spacing between the rows of cell in the array that decreases the cell density. The spacing of the cells reduces the probability of a long wire and/or net. The reduction of long wire and/or nets is critical because wire and/or net capacitance is a factor in timing. The priority of a low density pre-diffused gate array is to complete processing within 1 clock cycle. If first configurable circuit module is an FPGA the density of the cell also depends upon other factors including the ability of basic cells to realize a combination of signals.

Bus bridge 250 connects a second bus 251 to first bus 208. When a device on the second bus is being addressed on address bus 220 of first bus 208, address decoder sends a bridge select signal to bus bridge 250 via path 248. Bus bridge then translates signals between the protocols used on first bus 208 and second bus 251. Bus bridge 250 also generates selection signals for the peripheral device being used and routs the selection signals to the proper peripheral device via path 268 and 269.

Second bus 251 connects to bus bridge 250 to connect peripheral and other devices to processing unit 210. Second bus 251 includes read/write bus 255, address bus 260, and data bus 265. Read/write bus 255 transmits signals indicating whether data is being read from or written to the address indicated by signals on address bus 260. Address bus 260 transmits signals indicating the address associated with the data applied on data bus 265 for a particular peripheral device. Data bus 265 transmits data between a peripheral device and processing unit 210.

Peripheral devices 270 and 275 are circuitry that provide data to processing unit 210 to perform an application. The exact peripheral devices in microcontroller 200 do not matter for purposes of this invention and exact configurations of the device are omitted for brevity. One skilled in the art will recognize that any number of peripheral devices may be connected to second bus 251 depending on the configuration and requirements of the system including microcontroller 200.

In accordance with this exemplary embodiment of this invention, second bus 251 is also connected to second configurable circuit module 290. Second configurable circuit module is also connected to bus bridge 250 to receive signals indicating module 290 includes the address on address bus 260. Second configurable circuit module 290 is configurable to provide any application desired by a designer.

Second configurable circuit module circuit module 290 is connected to second bus 251 in order to allow the designer to program any application that requires high bandwidth communication with processing unit 210. An example of some applications include adding an UART device with infrared capability for communication with other devices.

Second configurable circuit module 290 may be a Field Programmable Gate Array (FPGA) or pre-diffused gate array logic. Preferably, second configurable circuit module 290 has a high cell density that may be required by lower bandwidth applications.

If second configurable circuit 285 is pre-diffused gate array logic, the space between cells is minimized to increase cell density. Space may be minimized by reducing the space between cells in a row. The minimization of the space between cells may cause unroutable and/or long nets that can decrease frequency. The frequency may be increased by adding a pipeline stage. The addition of a pipeline may increase latency which reduces bandwidth of the array. Alternatively, the size of the transistor in the last stage of each cell may also be varied to change the frequency of the array. Generally, as the size of the last transistor increases, the slope of the transition between Vdd and ground decreases. This increases the frequency of the array. If second configurable circuit module is an FPGA the density of the cell also depends upon other factors including the ability of basic cells to realize a combination of signals.

The above describes exemplary embodiments of microcontrollers in accordance with this invention. It is expected that those skilled in the art can and will design alternatives that infringe on this invention as set forth in the following claims either literally or through the Doctrine of Equivalents.

What is claimed is:

1. A microcontroller comprising:
a processing unit;
a plurality of high bandwidth peripheral devices;
a plurality of low bandwidth peripheral devices;
a first bus for connecting said plurality of high bandwidth peripheral devices to said processing unit;
a second bus for connecting said plurality of low bandwidth peripheral devices to said processing unit;
a first configurable circuit module connected to said first bus wherein said first configurable circuit module is configurable for high bandwidth applications; and
a second configurable module connected to said second bus wherein said second configurable circuit module is configurable for low bandwidth applications.

2. The microcontroller of claim 1 wherein said first configurable circuit module is configured to be programmed after manufacture of said microcontroller.

3. The microcontroller of claim 1 wherein said first configurable circuit module is configured to be programmed prior to manufacture.

4. The method of claim 1 wherein said first configurable circuit module has a cell density lower than said second configurable circuit module.

5. The microcontroller of claim 1 wherein said second configurable circuit module is configured to be programmed after manufacture of said microcontroller.

6. The microcontroller of claim 1 wherein said second configurable circuit module is configured to be programmed prior to manufacture.

7. The method of claim 1 wherein said second configurable circuit module has a cell density greater than said first configurable circuit module.

8. The microcontroller of claim 1 further comprising:
a bus bridge connecting said first bus to said second bus.

9. The microcontroller of claim 8 wherein said bus bridge controller translates signals between said first bus and said second bus.

10. The microcontroller of claim 1 wherein said first configurable circuit module includes a Field Programmable Gate Array.

11. The microcontroller of claim 1 wherein said first configurable circuit module includes Pre-diffused Gate Array logic.

12. The microcontroller of claim 1 wherein said second configurable circuit module includes a Field Programmable Gate Array.

13. The microcontroller of claim 1 wherein said second configurable circuit module includes Pre-diffused Gate Array logic.
